(19) United States
(12) Patent Application Publication
(10) Pub. No.: US 2023/0255382 A1
(43) Pub. Date: Aug. 17, 2023

(54) GLASS CHAIR MAT AND METHOD OF MANUFACTURE

(71) Applicant: Robert King, Santa Ana, CA (US)

(72) Inventor: Robert King, Santa Ana, CA (US)

(21) Appl. No.: 17/672,353

(22) Filed: Feb. 15, 2022

(51) Int. Cl. A47G 27/02

(52) U.S. Cl. CPC A47G 27/0206; A47G 27/0243

(57) ABSTRACT

A glass chair mat having a substantially planar sheet of tempered glass. The tempered glass has a thickness of between ⅛ to 1 inch, and an area of the glass chair mat is selected to cover an area that is greater than an area between the legs of the office chair, such that all legs of the office chair can rest upon the glass chair mat at the same time. The glass chair may further includes a printed layer disposed over at least part of the glass chair mat. In one embodiment, the glass chair mat of includes a printed layer that is formed by digital UV printing. In another embodiment, the glass chair mat of includes a printed layer that is formed by digital ceramic printing.

### BACKGROUND OF THE INVENTION

### Field of the Invention

This invention relates generally to chair mats, and more particularly to a glass chair mat and a method of printing on a glass chair mat.

### Description of Related Art

Chair mats for protecting a floor from wear and tear from an office chair, typically behind a desk, are well known. There are many patents on PVC, vinyl, or plastic chair mats, and these patents teach various methods of printing on the PVC material during manufacture for providing decorative features, corporate logos, and other desired designs, and many examples of these are described below. It is not known, however, to print on glass chair mats, due to the differences in the materials used and the methods of manufacture of such chair mats.

Robbins, III, U.S. Pat. No. 7,029,743, is an example of a PVC desk chair mat that includes an image formed within an area of the lower surface of the mat. The mat is formed of PVC, polypropylene, or vinyl, and the image is formed by silk screening, application of a decal, and molding the image into the surface.

Ney, U.S. Pat. No. 6,319,592, is another example of a PVC desk chair mat that is made of multiple layers, a mat base for contact with the floor, and a graphic layer having a decorative pattern. The graphic layer is connected with the mat base via a first adhesive material disposed. The floor mat also includes a transparent upper protective layer for contact by the chair. A second adhesive material is disposed between and interconnects the upper protective layer and the graphic layer. Because the graphic layer covers the mat base, the mat base may be made from regrind or reprocessed plastic material. The graphic layer is visible through the transparent protective layer.

Nelson, U.S. 2009/0004443, teaches a similar multi-layer plastic chair mat which includes a first decorative layer composed of melamine-formaldehyde impregnated decorative sheet. The chair mat also includes a central core layer that includes at least one resin impregnated sheet. The first decorative layer is coupled to the top first surface of the central core layer. The chair mat also includes a second decorative layer coupled to the bottom second surface of the central core layer, the second decorative layer being composed of a melamine-formaldehyde impregnated decorative sheet.

Aubin, U.S. 2006/0269726, teaches a protective mat having a body portion with an upper and lower surface, and further having a graphic image screen printed on the lower surface of the body such that the image is visible through the upper surface of the mat. The mat is made of vinyl, polyvinyl chloride, or propylene.

Grace-Moore, U.S. 2005/0129916, teaches a protective mat that has a plastic substrate layer (e.g., PVC, etc.), and a decorative material disposed on the substrate layer, and a seal layer disposed on the decorative material opposite the substrate layer. The decorative layer may be formed of paint, pencil, plastic, ink, paper, charcoal, polyurethane, crayon, glue, inlaid objects, and combinations thereof.

While printing on PVC, plastic, or vinyl materials is well known, it is most notably that none of these processes are used on glass chair mats. The only reference known at this time merely teaches etching and similar processes performed directly to the glass and prior to tempering. This reference, James, U.S. Pat. No. 8,168,286, teaches a glass chair mat wherein the patent notes (col 2, lines 54-67) that “prior to tempering, glass may be altered to enhance appeal and aesthetics. For example, while the glass is molten various metal oxides, sulfides, and other compounds may be added to color or stain the glass. Before the glass chair mat is tempered, the glass may be frosted to create an opaque appearance, or etched with designs or texture. Once tempered, the glass chair mat resists alteration thus coloring, cutting, etching, polishing, etc., should be finished before tempering. Alternatively, the . . . mat may be left transparent.”

The prior art teaches printing on plastic, PVC, or vinyl chair mats. However, the prior art does not teach digital printing on glass chair mats. Rather, the prior art teaches away from this form of printing on glass chair mats. The present invention fulfills these needs and provides further advantages as described in the following summary.

### SUMMARY OF THE INVENTION

The present invention teaches certain benefits in construction and use which give rise to the objectives described below.

The present invention provides a glass chair mat formed from a substantially planar sheet of tempered glass having a thickness of between ⅛ to 1 inch, wherein an area of the glass chair mat is selected to cover an area that is greater than an area between the legs of the office chair, such that all legs of the office chair can rest upon the glass chair mat at the same time. The glass chair may further includes a printed layer disposed over at least part of the glass chair mat.

In one embodiment, the glass chair mat of includes a printed layer that is formed by digital UV printing. In one embodiment, the glass chair mat of includes a printed layer that is formed by digital ceramic printing.

A primary objective of the present invention is to provide a glass chair mat having advantages not taught by the prior art.

Another objective is to provide a glass chair mat that includes desirably printed images covering at least some of the glass chair mat.

A further objective is to provide a glass chair mat having images that resist scratching, wear, and damage during use.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of a glass chair mat according to a first embodiment of the present invention.

FIG. 2 is a sectional view thereof taken along line 2-2 in FIG. 1.

FIG. 3 is a perspective view of a second embodiment of the glass chair mat.

FIG. 4 is a sectional view thereof taken along line 4-4 in FIG. 3.

FIG. 5 is a top perspective view of a third embodiment of the glass chair mat.

FIG. 6 is a bottom perspective view thereof.

### DETAILED DESCRIPTION OF THE INVENTION

The above-described drawing figures illustrate the invention, a glass chair mat that includes a digital printed layer.

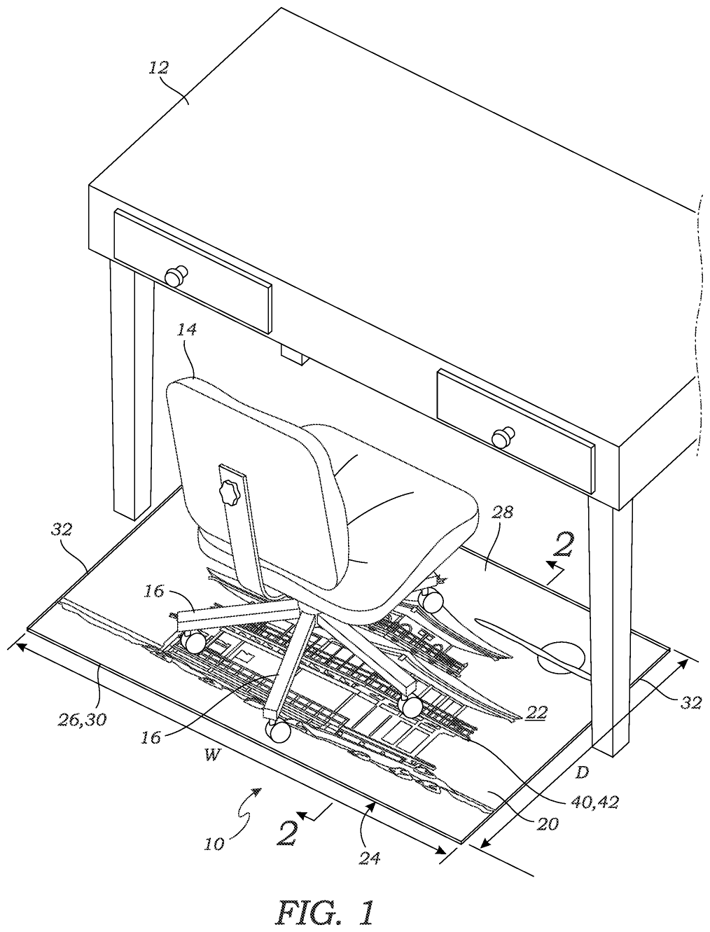

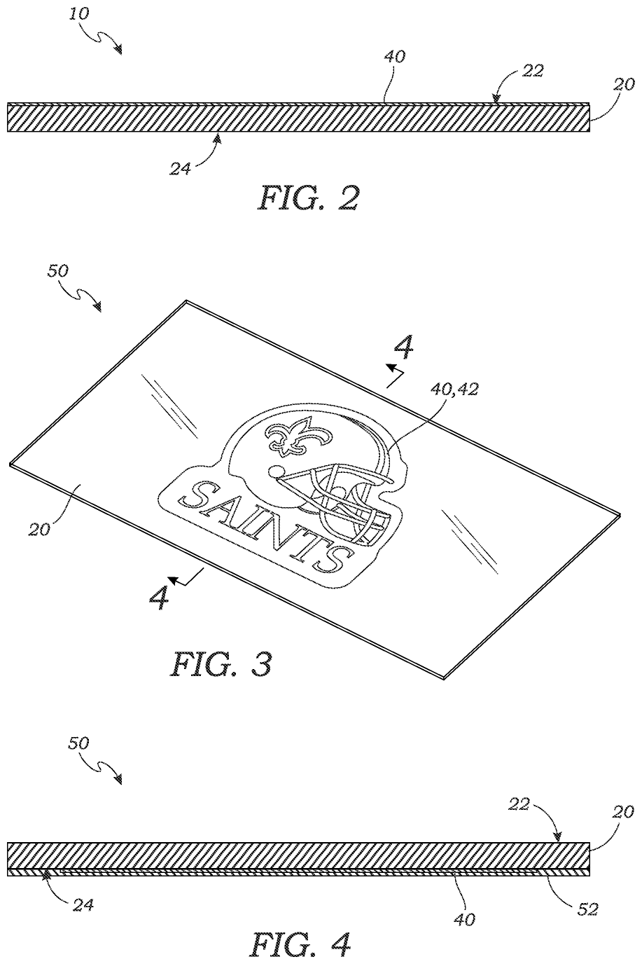

FIG. 1 is a perspective view of a glass chair mat 10 according to a first embodiment of the present invention. FIG. 2 is a sectional view thereof taken along line 2-2 in FIG. 1. As shown in FIGS. 1-2, the glass chair mat 10 includes a substantially planar sheet of tempered glass 20 having a thickness of between ⅛ to 1 inch. The glass chair mat 10 includes a top surface 22 and, opposed, a bottom surface 24, which together extends to an outer perimeter 26, in this case to a top edge 28, a bottom edge 30, and side edges 32.

As shown in FIGS. 1-2, the glass chair mat 10 has dimensions that are selected to fit behind a desk 12 and cover an area that is greater than an area between legs 16 of an office chair 14, such that all legs 16 of the office chair 14 can rest upon the glass chair mat 10 at the same time, but the glass chair mat 10 having dimensions that are smaller than 6 ft in any direction, in this case having a width W and a depth D that are smaller than 6 ft wide and 6 ft deep. In one embodiment, the width W is about 5 ft and the depth D is about 4 ft., although these dimensions may vary, so long as they are sufficient to support the office chair 14, without being so large that they can't readily be shipped or moved around. The general shape and size of the glass chair mat may vary, and while the glass chair mat 10 of FIG. 1 is rectangular, other shapes and configurations may be used without departing from the inventive concept disclosed herein.

As shown in FIGS. 1-2, the glass chair mat includes a printed layer 40 disposed over at least part of the glass chair mat 10. In the embodiment of FIG. 1, the printed layer 40 forms an image 42 that is visible to the user. The printed layer 40 may be formed on either the top or bottom surfaces 22 or 24, in this embodiment it is printed on the top surface 22 of the sheet of tempered glass 20. In this embodiment, the printed layer 40 forms the image 42 in the form of a panoramic image that covers substantially all of one or both surfaces 22 and/or 24 of the tempered glass 20.

In this embodiment, the printed layer 40 is formed by digital ceramic printing. In production, a digital printer, in this embodiment a flatbed digital printer, applies a digital ceramic ink (which includes ceramic frit and inorganic pigments) directly to a sheet of untampered glass. Drop fixation may be used to prevent dot gain, and an inline dryer may be used. The glass is then tempered, resulting in the sheet of tempered glass 20 with the printed layer 40 integrally formed. In the embodiment of FIG. 2, the printed layer 40 is formed on the top surface 22, but it could alternatively be formed on the bottom surface 24 in another embodiment.

FIG. 3 is a perspective view of a second embodiment of the glass chair mat 50. FIG. 4 is a sectional view thereof taken along line 4-4 in FIG. 3. In this embodiment, the printed layer 40 is formed by digital UV printing. In this embodiment, the printed layer 40 forms the image 42 in the form of a sports logo. In this embodiment, an organic ink is used to form the printed layer 40, which is then cured, and the cured ink may be covered with a protective layer 52 (shown in FIG. 4).

Since the organic ink may be more easily scratched, in this embodiment it is formed on the bottom surface 24, as shown in FIG. 4; however, in alternative embodiments, the ink may be applied to the top surface 22. The protective layer 52 may include a print flood of a solid ink (e.g., white ink), and it may include an adhesive backed vinyl (which may also be white or some other solid color), for providing a backdrop as well as protection.

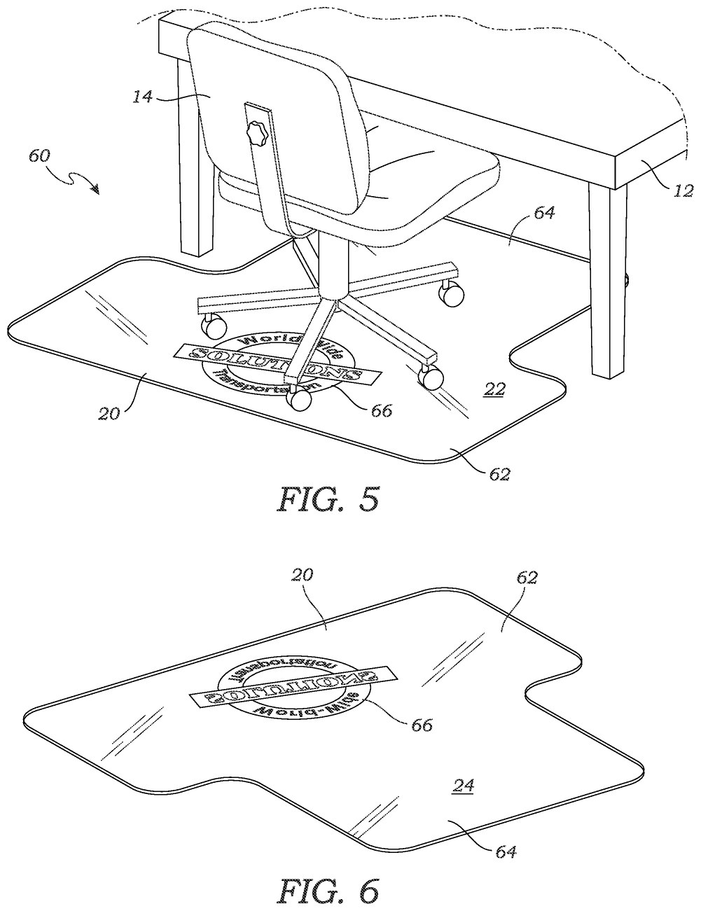

FIG. 5 is a top perspective view of a third embodiment of the glass chair mat 60. FIG. 6 is a bottom perspective view thereof. As shown in FIGS. 5-6, the glass chair mat 60 may have any shape desired for fitting behind or adjacent a desk or other piece of furniture, for protecting the floor from wear and tear, typically from an office chair. In this embodiment, a generally rectangular base 62 includes a protruding portion 64 that is intended to fit under the desk. Obviously, a person skilled in the art may devise a large number of sizes and shapes, and some shapes may be customized to a particular customer, to fit their unique work space, and such alternative sizes and shapes should be considered within the scope of the present invention.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/− 10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A glass chair mat for use with an office chair having legs, the glass chair mat comprising:
a substantially planar sheet of tempered glass having a thickness of between ⅛ to 1 inch, wherein an area of the glass chair mat is selected to cover an area that is greater than an area between the legs of the office chair, such that all legs of the office chair can rest upon the glass chair mat at the same time; and
a printed layer disposed over at least part of the glass chair mat.

2. The glass chair mat of claim 1, wherein the printed layer is formed by digital UV printing.

3. The glass chair mat of claim 1, wherein the printed layer is formed by digital ceramic printing.

4. A glass chair mat for use with an office chair having legs, the glass chair mat comprising:
a substantially planar sheet of tempered glass having a thickness of between ⅛ to 1 inch, wherein an area of the glass chair mat is selected to cover an area that is greater than an area between the legs of the office chair, such that all legs of the office chair can rest upon the glass chair mat at the same time, but the glass chair mat having dimensions that do not exceed 6 ft in any dimension; and
a printed layer disposed over at least part of the glass chair mat.

5. The glass chair mat of claim 4, wherein the printed layer is formed by digital UV printing.

6. The glass chair mat of claim 4, wherein the printed layer is formed by digital ceramic printing.
